(19) United States
(12) Patent Application Publication
(10) Pub. No.: US 2006/0198515 A1
(43) Pub. Date: Sep. 7, 2006

(54) Secure disc drive electronics implementation

(75) Inventors: Monty Aaron Forehand, Loveland, CO (US); Donald Preston Matthews JR., Longmont, CO (US); Laszlo Hars, Cranberry Township, PA (US); Donald Rozinak Beaver, Pittsburgh, PA (US); John Nestor, Pittsburgh, PA (US)

Correspondence Address: Robert P. Lenart;Pietragallo, Bosick & Gordon, One Oxford Centre, 38th Floor, 301 Grant Street, Pittsburgh, PA, 15219, US

(73) Assignee: Seagate Technology LLC, Scotts Valley, CA (US)

(21) Appl. No.: 11/070,910

(22) Filed: Mar. 3, 2005

(51) Int. Cl. H04L 9/28

(52) U.S. Cl. 380/28

(57) ABSTRACT

A data storage device comprises a storage medium and a controller including a cryptographic and security module for encrypting and decrypting data to be stored in and retrieved from the storage medium. The cryptographic and security module includes an interface for receiving commands from a processor, a secret root key, an encryption and decryption unit for encrypting and decrypting data using the secret root key, a buffer access unit for receiving encrypted data from and sending encrypted data to a memory, and a command controller for controlling the encryption and decryption unit and the buffer access unit in response to commands from the processor. The command controller implements mechanisms for movement of intermediate results within the cryptographic and security module to protect intermediate and plain text results from visibility outside the cryptographic and security module.

### FIELD OF THE INVENTION

This invention relates to disc drives with electronic features to support secure transactions, secure data storage, and security services.

### BACKGROUND OF THE INVENTION

Historically, security solutions in computer systems have been provided by the software or very slow or performance-poor hardware solutions. The software security solutions suffer from the fact that the software can be compromised through a network and other entry and attachment mechanisms. Existing hardware solutions such as smart cards are very slow and provide very little storage space, making them practical only for very small data sets and infrequent use.

This invention provides a disc drive system that includes electronically implemented security features.

### SUMMARY OF THE INVENTION

This invention provides a data storage device comprising a storage medium and a controller including a cryptographic and security module for encrypting and decrypting data to be stored in and retrieved from the storage medium. The cryptographic and security module includes an interface for receiving commands from a processor, a secret root key, an encryption and decryption unit for encrypting and decrypting data using the secret root key, a buffer access unit for receiving encrypted data from and sending encrypted data to a memory, and a command controller for controlling the encryption and decryption unit and the buffer access unit in response to commands from the processor.

In another aspect, the invention provides a cryptographic and security module for encrypting and decrypting data, the cryptographic and security module comprising an interface for receiving input commands, a secret root key, an encryption and decryption unit for encrypting and decrypting data using the secret root key, a buffer access unit for receiving encrypted data from and sending encrypted data to a memory, and a command controller for controlling the cryptographic and security module and the buffer access unit in response to the input commands.

### BRIEF DESCRIPTION OF THE DRAWINGS

FIG. 1 is a pictorial representation of a disc drive head disc assembly that can be included in a data storage system in accordance with the invention.

FIG. 2 is a block diagram of a data storage system constructed in accordance with this invention.

FIG. 3 is a block diagram of a monotonic block counter.

FIG. 4 is a block diagram of a root key block.

### DETAILED DESCRIPTION OF THE INVENTION

This invention provides a disc drive including circuitry that provides internal security features and cryptographic services. The circuitry includes a microprocessor executing security and cryptographic firmware, and provides an overall secure communication link to the disc drive's host interface adapter. By placing cryptographic and security components in the disc drive itself, enhanced security levels are provided, as these functions are performed behind the natural “firewall” at the disc drive interface and protected from the computer operating system, network, and other vulnerable connections.

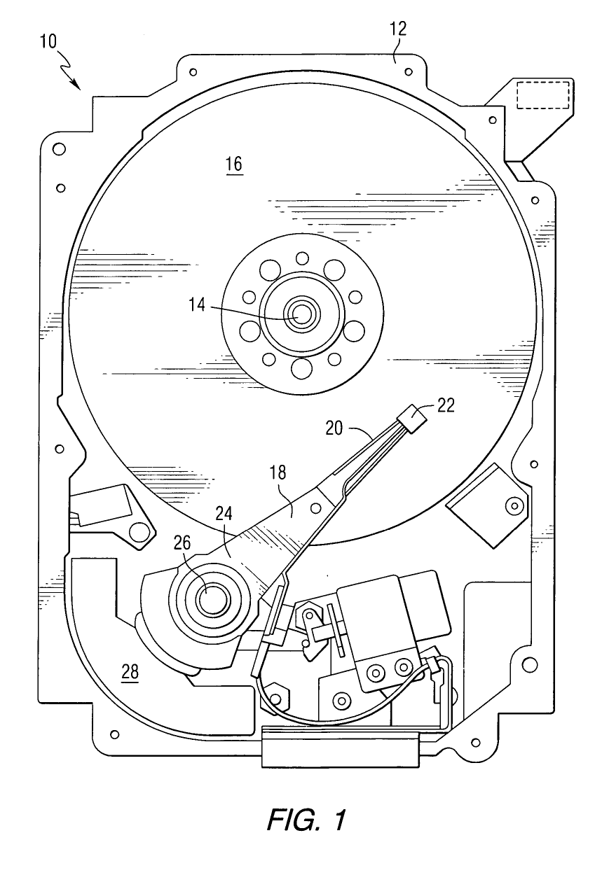

FIG. 1 is a pictorial representation of the mechanical portion of a disc drive 10 (commonly referred to as the Head Disc Assembly), that can be included in a data storage system in accordance with the invention. The disc drive includes a housing 12 (with the upper portion removed and the lower portion visible in this view) sized and configured to contain the various components of the disc drive. The disc drive includes a spindle motor 14 for rotating at least one data storage medium 16 within the housing, in this case a magnetic disc. At least one arm 18 is contained within the housing 12, with each arm 18 having a first end 20 with a recording and/or reading head or slider 22, and a second end 24 pivotally mounted on a shaft by a bearing 26. An actuator motor 28 is located at the arm's second end 24, for pivoting the arm 18 to position the head 22 over a desired sector of the disc 16. The actuator motor 28 is regulated by a controller that is not shown in this view.

The controller includes a printed circuit board that is attached to the mechanical portion of the disc drive, and contains electronics elements including motor control circuitry and arm positioning driver circuitry, a hard disc controller chip, and a DRAM buffer memory. The hard disc controller chip contains multiple elements including a non-volatile flash memory, a microprocessor (μP), a DRAM controller, a host interface unit, and a disc interface unit.

The hard disc controller chip can be an application specific integrated circuit (ASIC) containing optional read/write channel circuitry for formatting data for storage and retrieval from the disc drive media, a system microprocessor with associated program and data memories, a host unit for communication with the host computer system, a disc unit for communication of data to the read/write channel circuitry, a buffer arbitration and access unit for controlling data movement to the external buffer memory, and cryptographic and security circuitry to realize a secure disc drive implementation.

This invention adds a cryptographic and security module to the controller circuitry. The cryptographic and security module would be coupled to the buffer arbitration and access unit for storage and retrieval of data to and from the buffer memory. The cryptographic and security module is also coupled to the system microprocessor for communication of setup and command information from the system microprocessor to the cryptographic and security module and for retrieval of execution status from the cryptographic and security module to the system microprocessor.

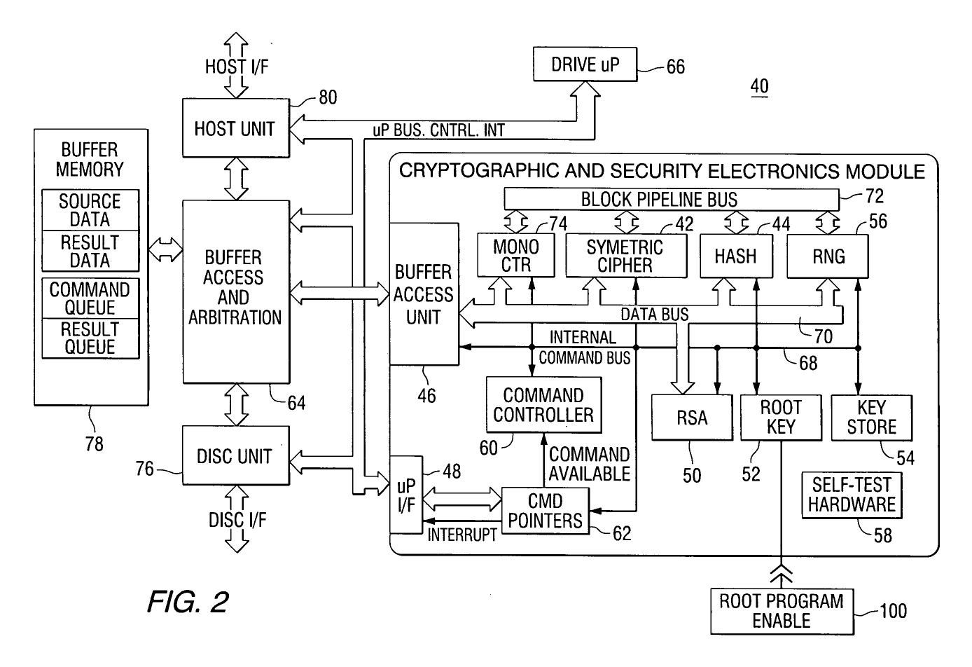

FIG. 2 is a block diagram of the controller circuitry. The cryptographic and security module 40 contains a symmetric encryption module (or cipher block) 42, a hashing module 44, a buffer access unit/direct memory access (DMA) 46, a microprocessor interface 48, an asymmetric encryption acceleration module 50, a root key 52, a key store 54, a random number generator (RNG) 56, self-test hardware 58, and a command controller 60 for receiving and interpreting commands from the drive firmware. An optional command pointer module 62 can be provided for storing pointers to optional command and result queues in the buffer memory.

The symmetric cipher block 42 is used to provide symmetric encryption of data. In one example the symmetric encryption module can include Advanced Encryption Standard (AES) and Triple Data Encryption Standard (DES) algorithms. The hash module 44 is provided for hashing of data. The hash module can be implemented using an SHA-1 Algorithm. The asymmetric encryption acceleration module 50 can use, for example, a 1024 & 2048 bit Rivest, Shamir, Adleman (RSA) algorithm.

The system microprocessor interface 48 provides the connection between the cryptographic and security module and the system microprocessor. This connection is used to transfer commands to and retrieve status from the cryptographic and security module. In one embodiment, this connection is a parallel address and data bus, but it may also be implemented with a serial port connection.

The system microprocessor interface also includes a hardware interrupt signal line that attaches directly to the system microprocessor interrupt controller. This interrupt will be used to notify the system microprocessor of the completion of a command, and of results available in the buffer.

The cryptographic and security module connects to a DRAM controller 64 and a drive microprocessor 66 as shown in FIG. 2. The cryptographic and security module contains an internal command bus 68 and data bus 70 for communication amongst internal sub-circuits and a block pipeline bus 72 for chaining of cryptographic operations. The buffer access unit and microprocessor interface circuitry adapt data flow to the protocols of the respective attached busses.

A monotonically increasing counter circuit 74 provides for secure knowledge of relative time. The cryptographically good random number generator 56 provides random numbers with technical infeasibility of prediction. The key store 54 can be a volatile memory for storing temporary keys.

The command controller 60 is provided for receipt and decoding of commands received from the system microprocessor and for tasking of the sub-circuitry. The command controller has the primary responsibility for decoding commands and setting microprocessor sub-blocks for the desired operation, and data flow. The command controller can also sequence the operations required to perform the RSA computations.

To preserve the integrity of the access to the cryptographic and security module it is important that there be no alternate accessibility to the cryptographic and security module, outside of the defined command interface described above. This will ensure that attackers cannot make malicious access to the module using debug or manufacturing pathways. Because of these constraints, the module can include an internal self-test unit.

This self-test unit can be used to verify the correct functionality of the module while preventing “back-door” access to the cryptographic and security module. The self-test module can also be invoked during normal operation of the chip, in a drive, to verify continued correct functionality of the cryptographic and security module. The self-test hardware 58 autonomously ensures correct functionality of the cryptographic and security circuitry.

The cryptographic and security module is coupled to the disc unit 76 through the buffer access and arbitration unit 64. A buffer memory 78 stores various information designated as source data, result data, command queue, and result queue. The buffer manager provides buffer access and arbitration. A host unit 80 interacts with the buffer manager. The drive microprocessor 66 is coupled to the host unit, buffer manager, disc unit, and the cryptographic and security module.

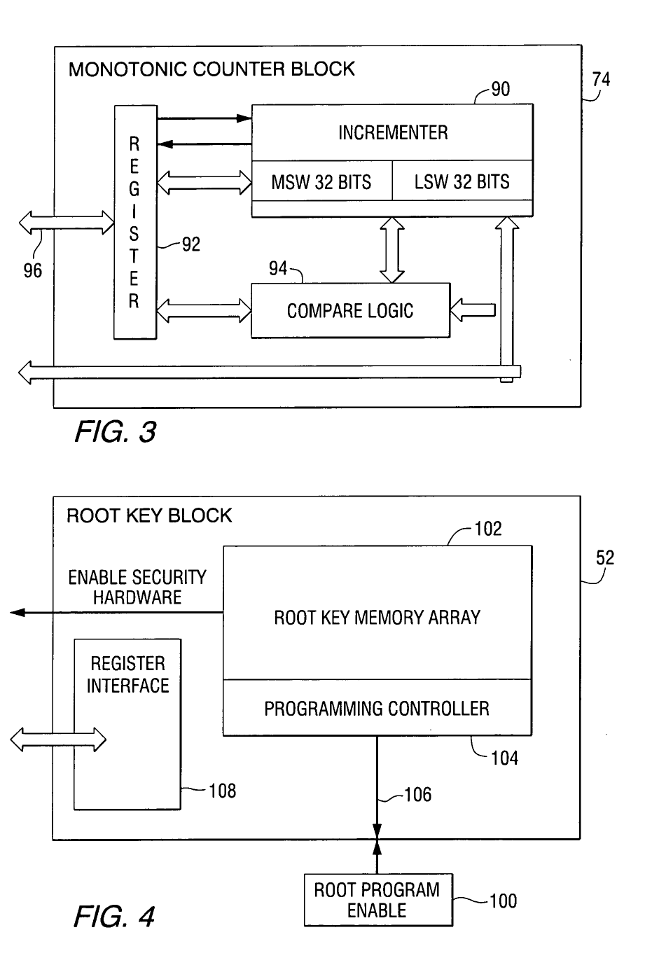

Referring to FIG. 3, the monotonically increasing counter circuit 74 contains incrementer circuitry 90, registering circuitry 92 for the current count value, compare logic 94 for comparing an input value to the current count value, and a register interface 96 for communication with the command controller circuitry. The compare logic contains circuitry for comparison of an input value to the current count with mathematical comparison results for greater than current count, less than the current count, or equal to the current count.

Referring to FIG. 4, the root key circuitry 52 contains a non-volatile root key memory array 102 including at least one additional memory element to enable the entirety of the cryptographic and security circuitry, a programming controller 104 for controlling the initial programming of the root key array, an interface 106 to the periphery of the hard disc controller ASIC to facilitate authorization and optionally the electrical energy required to program the root key memory array, and a register interface 108 for: (1) receipt of the programming commands from the command controller, (2) receipt of a random number from the random number generator, and (3) reporting the root key to the cipher and/or hash circuitry.

The data storage system of this invention includes distributed processing elements that are tasked by the controller processor function. This allows for off-line processing to take place without extensive interaction by the controller processor function. A set of cryptographic and security features is provided to facilitate secure drive functions. One of the security features is a root secret key that is only visible to the cryptographic hardware.

Each data storage system can have its own unique identifier or key that is permanently stored in the system. This identifier or key can be installed in the controller ASIC. To avoid supplier security issues, the identifier or key can be assigned (“burned”) at the system manufacturing facility, using for example, non-volatile flash or MRAM, fuses, or programmable logic.

Using this architecture, the disc drive microprocessor issues commands to the cryptographic and security module to perform cryptographic and security operations. The cryptographic and security module then retrieves data from the buffer, performs the operation, and stores the results to the buffer.

At the system level, the microprocessor initiates cryptographic and security operations within the electronics module. A generic operating sequence is as follows:

1. The disc drive microprocessor optionally loads data into the DRAM Buffer.

2. The disc drive microprocessor optionally loads a key to the key store (or has loaded a desired key to the key store in a previous operation).

3. The disc drive microprocessor loads the desired operation code and parameters to the command controller, initiating a command start.

4. The command controller initializes the appropriate cryptographic and security operation(s).

5. The command controller initializes the buffer access unit in the cryptographic and security module.

6. Optionally, data is retrieved from the buffer.

7. The cryptographic and/or security operation is performed.

8. The results are optionally stored back into the buffer.

9. The process returns to step 6 until all of the data is processed.

10. The command controller finalizes the operation and asserts an interrupt to the disc drive microprocessor.

The command controller supports one command at a time and performs it from start to finish, prior to receiving another command. The command controller supports numerous commands including: self test; data movement commands; random number generator commands; RSA arithmetic commands; key store commands; root key commands; symmetric encryption commands; and hashing commands.

The self test commands control the self test features of the cryptographic and security module. The data movement commands move buffer data from a source address to a destination address. The random number generator commands generate random numbers; generate whitened random numbers (hashed random number); optionally store to the buffer or a key store location X; and permit the microprocessor to unload (read) the random number. The RSA arithmetic commands control multiple operations described below. The key store commands load keys to the key store location X (note that the root key is not writeable); decrypt the provided key and store it to the key store location X; unload the key from the key store location X (note that the root key is not readable); clear the key location X; and move the key location X to the cipher unit.

The root key commands check the root key block integrity. The symmetric encryption commands encrypt/decrypt data in the buffer with an option for pre-decryption of the encryption key; and encrypt/decrypt data in the buffer and hash, with options for pre-encryption or post-encryption of the hash. The hashing commands hash data in the buffer.

The command controller receives commands and their parameters from the system microprocessor. The command controller may also utilize the optional command pointers to access a command queue stored in the disc drive DRAM buffer. Under this scenario, the drive firmware would load multiple commands into the drive's DRAM buffer, and then notify the command controller of the availability of one or more commands to be executed, via the command pointers block. The command controller would successively execute the commands in the command queue, until the command queue is exhausted. Correspondingly, each of the status results from each command would be stored in the result queue in the DRAM buffer.

The command controller provides two major benefits: (1) it allows for cryptographic and security functions to be performed behind a hardware fence creating a more secure system (For instance, the root key may be invoked as the encryption key for a particular operation without revealing the root key itself to the firmware or other hardware outside the cryptographic and security module); and (2) it provides the firmware with the facility to task the cryptographic and security module with tasks to be performed, freeing the firmware for other tasks, and thus, increasing the performance of the system.

The buffer access unit provides the protocol necessary to communicate with the buffer access and arbitration unit. Additionally, it provides direct memory access functionality. The buffer access unit, after initialization by the command controller, provides automated data movement between the cryptographic and security sub-modules, and the buffer memory.

The root key is the most trusted secret in the system. It is never revealed outside the cryptographic and security module. The root key may be invoked, by the overlying system, but, may never be read directly. The root key, in conjunction with the random number generator and the monotonic counter, provides the basis for the secure trustable system.

The root key is a permanent and non-changeable random value created after initialization of the device. In one example the root key is a programmable element using fuse or anti-fuse technology. It is recognized that other non-volatile memory technologies such as flash, ferro-RAM, and magnetoresistive RAM could be used in systems constructed in accordance with this invention.

Upon manufacture of the electronics, the root key is un-programmed. Additionally, there is an additional storage element that is un-programmed and disables any command execution in the cryptographic and security module. Prior to root key programming, all commands to the cryptographic and security module are rejected, except the program root key command. In a secure environment, after manufacture of the system, the root key is programmed according to the following procedure.

An external device (100 in FIG. 2) is attached to the circuit to provide the necessary energy to program the non-volatile storage elements comprising the root key. When the program root key command is issued to the command controller, the command controller initiates the generation of a random number in the random number generator. The generated random number is supplied to the root key circuitry. The command controller initializes the root key circuitry and instructs the root key module to program the random number to the non-volatile root key storage elements. Upon completion, the command controller performs randomness checks on the programmed root key. After passing the randomness checks, the command controller programs one additional storage element, preventing any further programming of the root key. Programming of this storage element also enables the full command set execution in the cryptographic and security module. After completion of this process, the root key is permanent and secret, and has not been and will not be exposed outside the cryptographic and security module.

Once the secret root key is established, additional keys may be boot-strapped from the root key. In one embodiment, the system firmware may desire a storable key to be used for protecting secure data to be stored on the disc drive's media. In this case both the data and key must be stored, but neither should be stored in plain text form.

To enable the module after the root key is initialized, one additional fuse can be burned to enable the block. This will establish that the root key has actually been burned (or at least that the voltage existed to burn the key) prior to enabling the cryptographic and security module.

To generate the additional key(s), the firmware loads a “Generate Secure Key” command to the command controller in the cryptographic and security module. The command controller instructs the random number generator to generate a random number and route that random number to the symmetric encryption unit, as the data input. The command controller loads the root key to the symmetric encryption unit providing the symmetric encryption key. The command controller instructs the symmetric encryption unit to perform the encryption of the random number. Upon completion, the encrypted random number is now the requested secure key. The command controller transfers the secure key to the DRAM buffer for use by the firmware. The command controller notifies the firmware of completion of the command. The firmware associates the secure key with a given data area and stores the secure key to the disc drive media. Upon read or write of the data area, the firmware commands the cryptographic and security module to encrypt or decrypt the data, and supplies the secure key to the cryptographic and security module. The command controller then decrypts the secure key using the root key, and provides the resultant plain-text key to the symmetric encryption module and performs the encryption or decryption of the data.

This feature has the benefit of never revealing the secure key in the clear, but has the added benefit of coupling this data to this particular disc drive (i.e. the data cannot be decrypted without the particular secret, random, root key present on this disc drive).

The key store is a set of register locations that store frequently used or secret keys. Storing of the frequently used keys allows greater firmware efficiency, by letting the firmware store the keys and reference them, rather than having to provide them for each operation. The key store also allows for using random keys that are never revealed to the system microprocessor. The microprocessor may issue a generate random key command to initiate the generation of a key that is then loaded to the key store by the cryptographic and security module. This stored random key may then be referenced on subsequent commands by the system microprocessor.

The monotonic counter provides a secure enumeration of relative time to the system. The monotonic counter value is only revealed in plain-text form inside the cryptographic and security module. The monotonic counter may only be incremented. It is automatically incremented by the command controller each time a command is received at the command controller. It is also incremented by the command controller at any time during a command when it provides greater security to increment the counter. The drive firmware may also issue a command to increment the counter, at its discretion. The drive firmware cannot read the count directly. However, the drive firmware may present a counter value to the cryptographic and security module and command it to compare the provided value to the current value of the monotonic counter.

Although stored in non-volatile registers within the cryptographic and security module, hardware and mechanisms are provided for providing secure non-volatile storage of the counter. The counter has two halves, a most significant half (MSH), and a least significant half (LSH). The LSH is volatile and resets to zero upon any power-up or reset event. The MSH is stored to a non-volatile memory after being encrypted by the root key.

In one embodiment, the LSH and the MSH are each 32 bits, allowing for in excess of 4 billion counts in each half. Upon power-up or other reset event, the cryptographic and security module will disable and reject all commands except the load monotonic counter command. The drive electronics will force the drive's microprocessor to begin code execution from an unchangeable ROM attached to the drive's microprocessor. The ROM code will begin execution and retrieve the encrypted MSH value from non-volatile memory (flash, MRAM, FRAM, etc. or the disc drive media). The ROM code will issue the load monotonic counter command to the cryptographic and security module, providing the encrypted MSH value as a parameter for the command. The cryptographic and security module will decrypt the MSH value using the root key and load the value to the MSH register of the monotonic counter. The ROM code will issue the increment monotonic counter command to the cryptographic and security module. The ROM code will issue the unload monotonic counter command to the cryptographic and security module. The cryptographic and security module will encrypt the MSH count value with the root key and provide the result to the system microprocessor. The remainder of the cryptographic and security module will be enabled, allowing all commands to be processed. The system microprocessor will store the encrypted MSH to the non-volatile memory location.

In an alternative embodiment it is recognized that non-volatile memory could be added to the cryptographic and security module and these steps could be implemented automatically and solely within the cryptographic and security module on a power-up or other reset event.

The monotonic counter will be incremented asynchronously. Rollover of the LSH will cause an increment of the MSH. On rollover of the LSH, the cryptographic and security module will stall, and wait until the MSH has been stored to disc prior to proceeding. The monotonic counter can notify the system microprocessor on setting of the 31st out of 32 bits, to allow the firmware time to increment and store the MSH prior to rollover.

The monotonic counter provides a comparison function which compares microprocessor supplied, encrypted counter value against the current count value and returns values of: Less Than, Equal to, or Greater Than. The monotonic counter will also provide a comparison function that inputs two encrypted counts and compares the two counts for Less Than, Equal To, or Greater Than. This allows the controller firmware to determine relative time without revealing the counter value itself outside of the cryptographic and security module.

The counter value will be provided to the crypto blocks 42 and 50 such that the counter value can be encrypted and/or hashed and returned to the system microprocessor. For enhanced security it is preferred that the count not be provided in the clear, and the actual count value is never seen outside the cryptographic and security module in the clear. Several cryptographic services can be provided to the firmware and host services, including: DES/3DES; AES; SHA-1; and RSA.

After reset initialization, the drive's microprocessor may unload the current encrypted count, increment the count, or compare an encrypted value to the current count. Note that the drive's microprocessor never sees the actual count value, but rather sees the count after encryption by the root key.

The random number generator provides cryptographically good random numbers, meaning that it is statistically infeasible to predict the next value. The cryptographic and security module uses the generated random numbers in conjunction with the hash electronics to whiten the generated random numbers to produce normally distributed values.

The cryptographic and security module provides mechanisms whereby the generated random numbers may be provided to any of the cryptographic electronics modules without firmware control. This allows for random numbers to be used within the cryptographic and security module without revealing them outside the module.

The RSA (Rivest, Shamir, Adelman) electronics provide big-number mathematical electronics to accelerate the industry standard RSA algorithms for asymmetric encryption and public/private key authentication. The command controller tasks the RSA electronics and provides all data and key movement functions to and from the module. The RSA module may be implemented at various levels, including a completely automated self-contained unit that performs all RSA functions. For example, the RSA module can be implemented as a mathematical acceleration engine performing the following operations on up to 256-bit operands:

Addition, Subtraction, Greater Than, Less Than, Equality.

Multiply, Modular Multiply, Division, Square, Reciprocal.

Modulus, Modular Exponent, Multiplicative Inverse.

The symmetric cipher electronics provide industry standard encryption and decryption. In one example, these include DES (Data Encryption Standard), Triple DES, and AES (Advanced Encryption Standard). The command controller tasks the symmetric cipher and provides all data and key movement functions to the module. It is recognized that additional or alternative symmetric cipher algorithms could be used in systems constructed in accordance with this invention.

The hashing electronics provide industry standard hashing of data, keys, and random numbers. In one example, the SHA-1 algorithm is implemented. The command controller tasks the hashing engine and provides all data, random numbers, keys, and initial value movements to and from the module. It is recognized that additional or alternative hashing algorithms could be used in systems constructed in accordance with this invention.

The cryptographic and security module provides mechanisms for chaining all subelectronics modules including cipher and hash modules. This allows for doing both operations totally within the cryptographic and security module without revealing the intermediate result outside the module. This results in increased security levels that can be achieved.

The architecture of FIG. 2 will support cryptographic operations on user data sectors in the disc unit, and has facilities to manage data flow in the buffer memory using the buffer manager. The architecture also supports cryptographic operations on non-sector data, or any data that the system can put into the buffer. The architecture has the capability to run at normal user data throughput rates contingent upon the hardware scaling options chosen, and contingent upon the available buffer bandwidth.

The key store could be implemented as a “Locking Store” of changeable Non-Volatile (NV) memory resident in the controller ASIC that contains the microprocessor. This locking store would contain primary keys, and other “secret” information, that are isolated from physical attack. In one example system, the locking store could be on the disc. That example would provide protection from a hostile host attack, but not a physical drive attack (logic analyzer, etc.).

This architecture will support cryptographic operations on user data sectors, and has facilities to manage data flow in the buffer using the buffer manager. Cryptographic operations are also supported on non-sector data, or any data that the system can put into the buffer. The architecture has the capability to run at normal user data throughput rates contingent upon hardware scaling options chosen, and contingent upon available buffer bandwidth.

The electronics architecture includes electronics elements to accelerate cryptographic operations, as well as provide higher levels of security with secure memory and counter elements in hardware. The invention provides for distributed processing elements that are tasked by the controller processor function. This allows for off-line processing to take place without extensive interaction by the controller processor function.

This invention improves on the performance and security level of the firmware-only solution, by accelerating cryptographic operations, to provide more performance and thus, a larger application space, and moves key security operations into electronics hardware, providing even greater “firewall” security.

The systems of this invention provide cryptographic coupling of the drive's electronics to encrypted data on the drive's media. Industry standard algorithms can be combined with control and security circuitry to provide cryptographic and security electronics functions.

While this invention has been described in terms of several examples, it will be apparent to those skilled in the art that various changes can be made to the disclosed examples without departing from the scope of the invention as set forth in the following claims. For example, the cryptographic and security module could be used in combination with other storage devices.

What is claimed is:

1. A data storage system comprising:
a storage medium; and
a controller including a cryptographic and security module for encrypting and decrypting data to be stored in and retrieved from the storage medium, wherein the cryptographic and security module includes:
an interface for receiving commands from a processor;
a secret root key;
an encryption and decryption unit for encrypting and decrypting data using the secret root key;
a buffer access unit for receiving encrypted data from and sending encrypted data to a memory; and
a command controller for controlling the cryptographic and security module and the buffer access unit in response to commands from the processor.

2. The data storage system of claim 1, wherein the command controller implements mechanisms for movement of intermediate results within the cryptographic and security module to protect intermediate and plain-text results from visibility outside the cryptographic and security module.

3. The data storage system of claim 1, wherein the command controller implements mechanisms for usage of the root key in conjunction with other cryptographic elements in the cryptographic and security module.

4. The data storage system of claim 1, wherein the cryptographic and security module further comprises:
self test hardware.

5. The data storage system of claim 1, wherein the cryptographic and security module further comprises:
a monotonic counter that is incremented by the command controller.

6. The data storage system of claim 5, wherein the monotonic counter includes compare logic for comparing a first count value with a second count value.

7. The data storage system of claim 1, wherein the cryptographic and security module further comprises:
a random number generator for generating a random number for use by the encryption and decryption unit.

8. The data storage system of claim 1, wherein the encryption and decryption unit comprises:
a symmetric cipher unit; and
a hash unit.

9. The data storage system of claim 1, wherein the cryptographic and security module further comprises:
a command pointers register for identifying commands to be executed by the command controller.

10. The data storage system of claim 1, wherein the cryptographic and security module further comprises:
a key store for storing user keys generated from the root key.

11. The data storage system of claim 1, further comprising:
a head disc assembly including the storage medium.

12. The data storage system of claim 11, further comprising:
a buffer memory coupled to the head disc assembly and the cryptographic and security module; and
wherein the processor controls the operation of the head disc assembly, the cryptographic and security module, and the buffer memory.

13. The data storage system of claim 1, further comprising:
an RSA module for accelerating asymmetric encryption and public/private key authentication.

14. The data storage system of claim 1, further comprising:
a host unit for interfacing with a host computer;
a disc unit for interfacing with the storage medium; and
wherein the processor controls the host unit, the disc unit, and the cryptographic and security module.

15. A cryptographic and security module for encrypting and decrypting data, the cryptographic and security module comprising:
an interface for receiving input commands;
a secret root key;
an encryption and decryption unit for encrypting and decrypting data using the secret root key;
a buffer access unit for receiving encrypted data from and sending encrypted data to a memory; and
a command controller for controlling the cryptographic and security module and the buffer access unit in response to the input commands.

16. The cryptographic and security module of claim 15, wherein the command controller implements mechanisms for movement of intermediate results within the cryptographic and security module to protect intermediate and plain-text results from visibility outside the cryptographic and security module.

17. The cryptographic and security module of claim 15, wherein the command controller implements mechanisms for usage of the root key in conjunction with other cryptographic elements in the cryptographic and security module.

18. The cryptographic and security module of claim 15, wherein the cryptographic and security module further comprises:
self test hardware.

19. The cryptographic and security module of claim 15, wherein the cryptographic and security module further comprises:
a monotonic counter that is incremented by the command controller.

20. The cryptographic and security module of claim 19, wherein the monotonic counter includes compare logic for comparing a first count value with a second count value.

21. The cryptographic and security module of claim 15, wherein the cryptographic and security module further comprises:
a random number generator for generating a random number for use by the encryption and decryption unit.

22. The cryptographic and security module of claim 15, wherein the encryption and decryption unit comprises:
a symmetric cipher unit; and
a hash unit.

23. The cryptographic and security module of claim 15, wherein the cryptographic and security module further comprises:
a command pointers register for identifying commands to be executed by the command controller.

24. The cryptographic and security module of claim 15, wherein the cryptographic and security module further comprises:
a key store for storing user keys generated from the root key.

25. The cryptographic and security module of claim 15, further comprising:
an RSA module for accelerating asymmetric encryption and public/private key authentication.
